(19) United States
(12) Patent Application Publication
(10) Pub. No.: US 2005/0067205 A1
(43) Pub. Date: Mar. 31, 2005

(54) Hood lift

(75) Inventors: Hiroaki Watanabe, Hino-shi (JP); Takayuki Fujimoto, Hino-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: HINO MOTORS, LTD., Hino-shi (JP)

(21) Appl. No.: 10/941,819

(22) Filed: Sep. 16, 2004

(30) Foreign Application Priority Data
Sep. 26, 2003 (JP) 2003-335218

(51) Int. Cl. B62D 25/10

(52) U.S. Cl. 180/69.21

(57) ABSTRACT

In a hood lift capable of supplementing operational force of forwardly lifting and tilting a vehicle hood by torsional restoring force of torsion bars, a zero or neutral position of the torsion bars is set around a tilted balance or neutral position of the hood so as to suppress opening velocity and shocks when a hood reaches its maximum open degree.

### CROSS-REFERENCE TO RELATED APPLICATION

This application is related to and claims priority, under 35 U.S.C. § 119, from Japanese Patent Application No. 2003-335218, filed in the Japanese Patent Office on Sep. 26, 2003, the entire contents of which is hereby incorporated by reference herein.

### BACKGROUND OF THE INVENTION

1. Field of the Invention

This invention generally relates to vehicles with a hood and more specifically to a hood lift which power assists or supplements operational force of lifting and tilting the hood forwardly into an open position.

2. Discussion of Background

In large-scale vehicles with a hood such as trucks and school buses, the vehicle hood may be lifted and tilted forwardly into an open position about tilt pivots on front ends of side rails, whereby maintenance and inspection of an engine can be conducted with the hood being lifted and tilted.

Some large-scale vehicles with a hood are provided with a hood lift which supplements operational force of lifting and tilting the hood forwardly into an open position by means of torsional restoring force of torsion bars, thereby relieving physical labor in a hood lifting and tilting operation. See, for example, U.S. Pat. No. 5,730,239.

However, in such typical, conventional hood lifts using torsion bars, a zero or neutral position of the torsion bars where torsional restoring force of them disappears is set at a fully open position of the hood 1 as shown in two-dot-chain lines in FIG. 1 so that the opening motion of the hood 1 may intensify just before the hood is fully opened, resulting in a problem that an opening velocity and shocks are too intensive when the hood 1 reaches its maximum open degree.

More specifically, as shown in FIG. 2, gravitational moment of the hood 1 acts in a direction opposite to that of the torsional restoring force of the torsion bars during lift and tilt of the hood 1 from its fully closed position (see the position shown in solid lines in FIG. 2) to its tilted balance or neutral position (see the position shown in one-dot-chain lines in FIG. 2) or during its motion in an angular range X shown in FIG. 2 whereas the gravitational moment of the hood 1 reverses and acts in a direction in accordance with that of the torsional restoring force of the torsion bars during lift and tilt of the hood 1 from its tilted balance or neutral position to its fully open position (see the position shown in two-dot-chain lines in FIG. 2) or during its motion in an angular range Y shown in FIG. 2. As a result, during the motion of the hood 1 from its neutral position to its fully open position, the hood 1 may suddenly fall down, resulting in a problem that an opening velocity and shocks are too intensive when the hood 1 reaches its maximum open degree.

In the specification, the tilted balance or neutral position of the hood 1 refers to a lifted and tilted position of the hood 1 where a center of gravity 4 of the hood 1 is just above the tilt pivots 3 on the front ends of the side rails 2; the fully open position of the hood 1 where the hood 1 reaches at its maximum open degree refers to a lifted and tilted position of the hood 1 passed past its neutral position which is defined by a stopper mechanism which may comprise, for example, stopper wire 6 (see FIG. 1) interconnecting an upper end of a radiator support member 5 (see FIG. 1) and a back surface of the hood 1.

### BRIEF SUMMARY OF THE INVENTION

The invention was made in view of the above and has its object to provide a hood lift which can suppress an opening velocity and shocks when the hood reaches its maximum open degree.

The invention is directed to a hood lift capable of supplementing operational force of lifting and tilting a vehicle hood forwardly into an open position and is characterized in that a zero or neutral position of torsion bars where torsional restoring force of them disappears during forward lift and tilt of the hood is set around a tilted balance or neutral position of the hood.

Thus, during forward lift and tilt of the hood from its fully closed position to its tilted balance or neutral position, the torsional restoring force of the torsion bars acts in a direction of decreasing gravitational moment of the hood to thereby supplement operational force of lifting and tilting the hood; then, during further forward lift and tilt of the hood passed past its tilted balance or neutral position, the torsion bars twist reversely to generate reversed torsional restoring force so that, in spite of the fact that the gravitational moment of the hood reverses, the torsional restoring force of the torsion bars still act in a direction of decreasing the gravitational moment of the hood, whereby any sudden falling-down of the hood is braked and the opening velocity and shocks are suppressed when the hood reaches its maximum open degree.

An embodiment of the invention will be described in conjunction with the drawings.

### BRIEF DESCRIPTION OF THE DRAWINGS

FIG. 1 is a schematic view showing lifting and tilting of a typical vehicle with a hood;

FIG. 2 shows lifting and tilting of the hood of FIG. 1 in stepped manner,

FIG. 3 is a perspective view showing an embodiment of the invention;

FIG. 4 is a perspective view showing the whole of the torsion bars of FIG. 3; and

FIG. 5 is a view for explanation on setting a zero or neutral position of the torsion bar.

### DETAILED DESCRIPTION OF THE PREFERRED EMBODIMENT

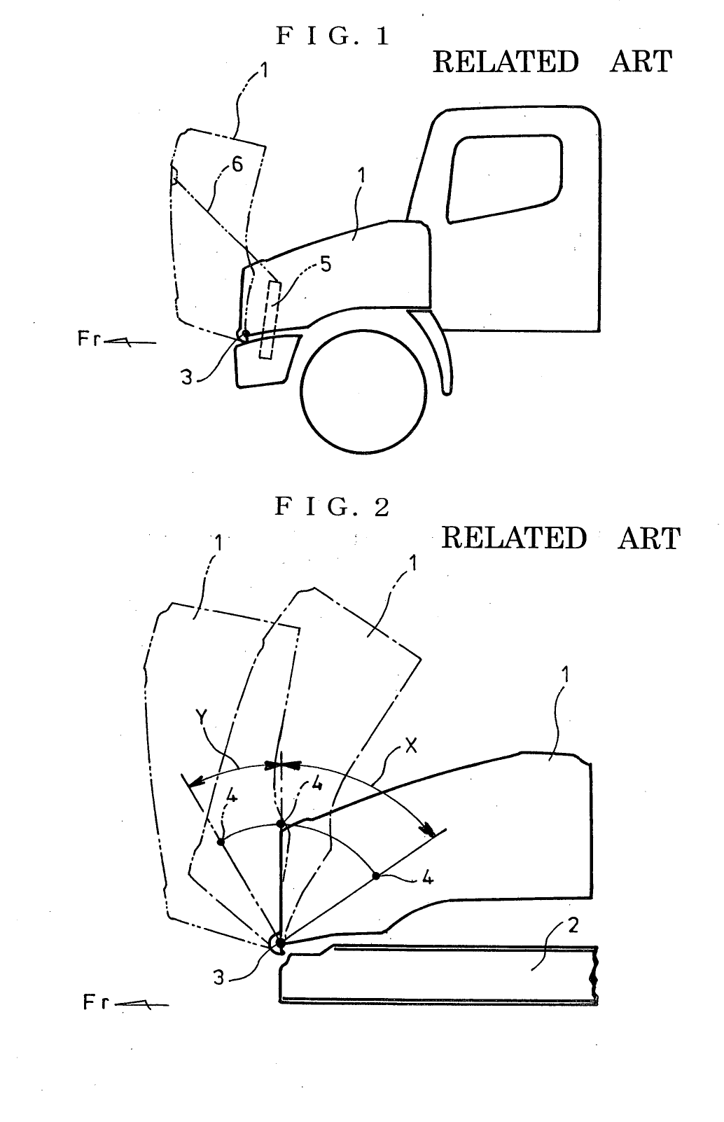

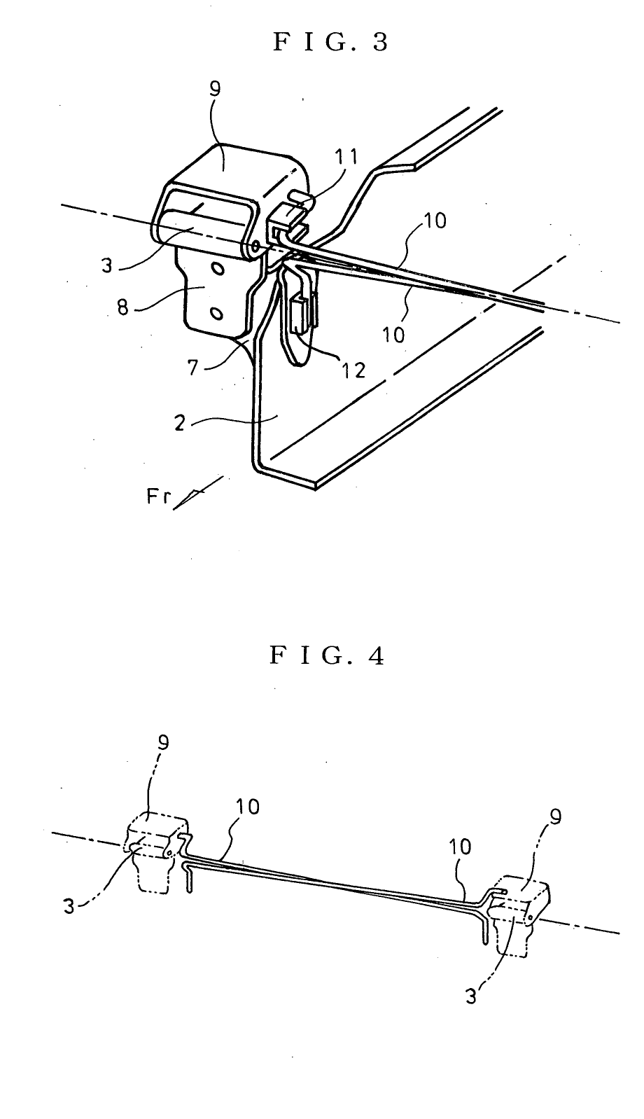

FIGS. 3-5 show an embodiment of the invention. In the description hereinafter, reference is also made to FIGS. 1 and 2 used in the explanation on the background of the invention.

As shown in FIG. 3, in a hood lift according to the invention, each lateral side rail 2 has a front end to which a tilt pivot 3 is fixed through brackets 7 and 8. Pivotally fitted over the tilt pivot 3 is a hood hinge 9 which is integrally fitted to a back surface of a hood 1 (see FIGS. 1 and 2) through, for example, angle plates.

Although FIG. 3 shows only a right-side structure of the vehicle; in fact, torsion bars 10 extend laterally of the vehicle to interconnect the left hood hinge 9 and right side rail 2 and the right hood hinge 9 and left side rail 2 such that, when the hood 1 is closed, the torsion bars 10 axially twist and torsional restoring force of them acts in the direction of opening the hood 1.

More specifically, as shown in FIGS. 3 and 4, the torsion bars 10 are of shapes symmetrical to each other like mirror image and are arranged along an extension of axes of the tilt pivots 3 in a manner of being slightly crossed with each other. One of longitudinal end portions of the torsion bar 10 is bent in the form of crank, is integrally held via a bracket 11 by an inner side surface of one of the hood hinges 9 and is inserted at its distal end into the inner side surface of the one hood hinge 9 at a side away from the tilt pivot 3; the other longitudinal end portion of the torsion bar 10 is inclined backwardly of the vehicle and then bent down to be integrally held via a bracket 12 by an inner side surface of the front end of the side rail 2 below the other hood hinge 9.

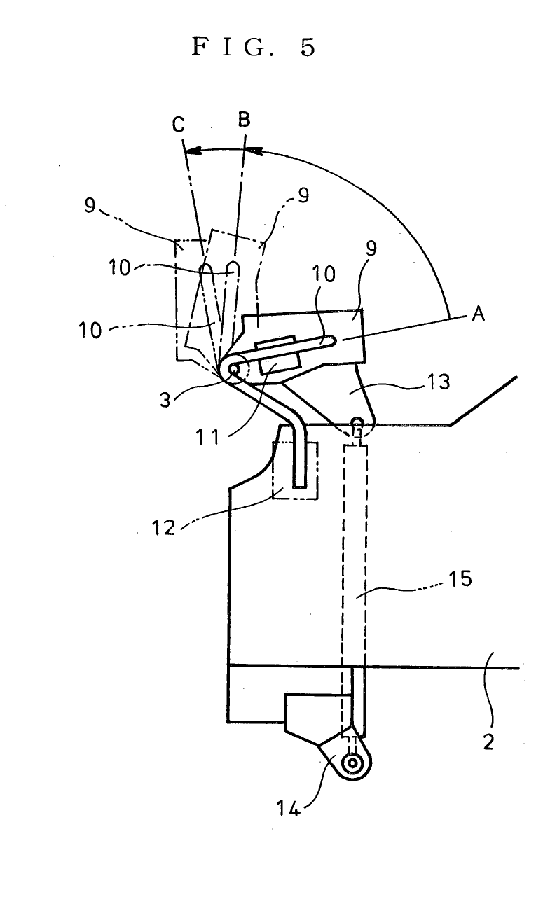

The most characteristic feature of the embodiment is that a zero or neutral position of torsion bars where torsional restoring force of them disappears during forward lift and tilt of the hood is set around a tilted balance or neutral position of the hood 1 (see the position in FIGS. 5 and 2 shown by one-dot-chain lines).

More specifically, the tilted balance or neutral position of the hood 1 (i.e., the tilted position where a center of gravity 4 of the hood 1 is just above the tilt pivots 3) is a position B shown in FIG. 5 by one-dot-chain lines where the torsion bars 10 have no twist deformation; closing procedure of the hood 1 from its neutral position B to the fully closed position A causes the one end portions of the torsion bars 10 to be pushed down together with the hood hinges 9, which axially twists the respective torsion bars 10 to thereby generate torsional restoring force which supplements operational force of lifting and tilting the hood forwardly into an open position.

The embodiment in FIG. 5 shows an example where a velocity-proportional type oil damper 15 is arranged between a bracket 13 on an outer side surface of the hood hinge 9 and a bracket 14 on an outer lower end of the front end of the side rail 2. Provision of such oil damper 15 will relieve any shocks during closing the hood 1.

In the hood lift thus constructed, during forward lift and tilt of the hood 1 from its fully closed position A to the neutral position B, the torsional restoring force of the torsion bars 10 act in the direction of decreasing the gravitational movement of the hood 1 to supplement the operating force of the hood 1 forwardly into an open position. During further forward lift and tilt of the hood 1 passed past the neutral position B, the torsion bars 10 reversely twist to generate reversed torsional restoring force so that, in spite of the fact that the gravitational moment of the hood 1 reverses, the torsional restoring force of the torsion bars 10 still act in a direction of decreasing the gravitational moment of the hood 1, which will brake any sudden falling-down of the hood 1 and will suppress the opening velocity and shocks when the hood 1 reaches its maximum open degree, i.e., when the hood 1 is opened into the fully open position C in FIG. 5 shown by two dot chain lines.

Therefore, according to the above embodiment, during further forward lift and tilt of the hood 1 passed past the neutral position B, the torsion bars 10 twist reversely to generate reversed torsional restoring force so that any sudden falling-down of the hood 1 can be braked and the opening velocity and shocks can be suppressed when the hood 1 reaches its maximum open degree, thereby attaining improved safety and reduction in any damage of the vehicle during the operation of lifting and tilting the hood 1 forwardly.

It is to be understood that the invention is not limited to the above-mentioned embodiment and that various changes and modifications may be effected within a scope and spirit of the invention.

1. A hood lift for a vehicle with a hood comprising a torsion bar, a zero or neutral position of the torsion bar where torsional restoring force of the torsion bar disappears during forward lift and tilt of the hood being set around a tilted balance or neutral position of the hood.
